(19) United States
(12) Patent Application Publication
(10) Pub. No.: US 2019/0128610 A1
(43) Pub. Date: May 2, 2019

(54) GRIPPING TOOL AND A METHOD FOR REMOVING A HEAT EXCHANGER PLATE FROM A FURNACE WALL

(71) Applicant: OUTOTEC (FINLAND) OY, Espoo (FI)

(72) Inventors: Ronald COLEMAN, Barrie (CA); Harold HILDEBRANDT, Collingwood (CA)

(21) Appl. No.: 16/220,011

(22) Filed: Dec. 14, 2018

Related U.S. Application Data
(63) Continuation of application No. PCT/FI2016/050459, filed on Jun. 23, 2016.

(51) Int. Cl. F27D 1/16; F27D 25/00

(52) U.S. Cl. CPC F27D 1/1694; F27D 2001/0046; F27D 25/001

(57) ABSTRACT

A gripping tool for removing a heat exchanger plate from a furnace wall, the gripping tool including a base having a mechanical attachment device for releasably fixing to a tool end of a boom, and a gripping assembly carriage equipped with at least a fork extending, when in use, substantially horizontally from the gripping assembly carriage. The gripping assembly carriage further includes a clamp assembly having a clamp arm equipped with at least a clamp pad, wherein said clamp arm extends substantially in the direction of the at least one fork and is movable towards and away from the at least one fork for clamping a heat exchanger plate between the fork and the clamp pad.

### CROSS-REFERENCE TO RELATED APPLICATIONS

This application is a continuation of PCT International Application No. PCT/2016/050459 filed Jun. 23, 2016, the disclosure of this application is expressly incorporated herein by reference in its entirety.

### FIELD OF THE DISCLOSURE

The present disclosure relates to removing heat exchangers from a furnace wall. Particularly, the present disclosure concerns a gripping tool and a method for removing a heat exchanger plate from a furnace wall.

### BACKGROUND OF THE DISCLOSURE

Conventional furnaces have a given campaign life after which the furnace has to be demolished and possibly rebuilt thereafter. Typically furnaces are equipped with heat exchanger plate, which are used, during the operation of the furnace, for cooling down the furnaces wall. These heat exchanger plates are typically recovered during demolition. Additionally, heat exchanger plates wear during use, and may thus need to be replaced even during the campaign life of the furnace.

Such heat exchanger plates are typically solid metal blocks equipped with cooling liquid conduits. Thus the heat exchanger plates are very heavy, and consequently, cumbersome to both remove from the furnace wall and to subsequently handle at the demolition site. Additionally, the task of removing and handling the heat exchanger plates is further complicated by the demolition or maintenance site being very rugged and having an uneven surface due to the nature of the operation.

Moreover, the heat exchanger plates are often made of copper due to its good heat conducting properties. Consequently, the related material cost is very significant, and the heat exchanger plates are often reused or refurbished. It is thus desired to recover the heat exchanger plates without destroying them.

Conventionally, heat exchanger plates have been removed from furnace walls one by one, by demolishing the furnace wall immediately surrounding the heat exchanger, attaching lifting lugs to the heat exchanger, and rigging the heat exchanger with chains and pulling/lifting the heat exchanger plate out form the wall.

### BRIEF DESCRIPTION OF THE DISCLOSURE

An object of the present disclosure is to provide a gripping tool and a method for facilitating the removal of heat exchange plates from a furnace wall, and the handling of the heat exchanger plates at the demolition or maintenance site.

The objects of the disclosure are achieved by a gripping tool and a method for removing a heat exchanger plate from a furnace wall, which are characterized by what is stated in the independent claims. The preferred embodiments of the disclosure are disclosed in the dependent claims.

The disclosure is based on the idea of providing a gripping tool, in which the heat exchanger plate can be clamped between at least one fork and at least one clamp pad such that the heat exchanger plate can not fall of the at least one fork.

An advantage of the gripping tool and method according to the disclosure is that the time required to remove a heat exchanger plate from a furnace wall is greatly reduced as the need for several steps, such as attaching lifting lugs to the heat exchanger plates and rigging the heat exchanger plates, are eliminated. Working safety is also improved as these eliminated steps require personnel to be at a close proximity to the heat exchanger plates, where the risks related to falling pieces or collapsing of the furnace wall is considerably higher than at a distance.

Moreover, the use of gripping tool according to the disclosure enables the use of a mobile working equipment in the handling and transportation of the heat exchanger plates at the rugged demolition site as the falling off of the heat exchanger plate from the at least one fork is prevented by the at least one clamp pad clamping the heat exchanger plate between the fork and the clamp pad.

### BRIEF DESCRIPTION OF THE DRAWINGS

In the following the disclosure will be described in greater detail by means of preferred embodiments with reference to the accompanying drawings, in which

FIG. 1 illustrates a perspective view of a gripping tool according to an embodiment of the disclosure as seen from the side of the gripping assembly carriage;

FIG. 2 illustrates a perspective view of a gripping tool according to an embodiment of the disclosure as seen from the side of the mechanical attachment means;

FIG. 3 illustrates a side view of a gripping tool according to an embodiment of the disclosure;

FIG. 4 illustrates a perspective view of a gripping tool according to an embodiment of the disclosure as seen from the side of the gripping assembly carriage, while the clamp arm has been moved such that the clamp pads are pressing against the forks;

FIG. 5 illustrates a perspective view of a gripping tool according to an embodiment of the disclosure in a situation in which a typical heat exchanger plate is carried by the forks of the gripping tool while the clamp arm has not yet been driven downwards into a clamping position.

### DETAILED DESCRIPTION OF THE DISCLOSURE

According to an aspect of the disclosure, a gripping tool 1 is provided for removing a heat exchanger plate from a furnace wall. Such an operation may become necessary during demolition of said furnace after its campaign life, or alternatively, during maintenance for replacing a worn heat exchanger plate, i.e. during the campaign life of the furnace.

The gripping tool 1 comprising a base 2 having mechanical attachment means 3 for releasably fixing said gripping tool to a tool end of a boom of a mobile working equipment, so as to be operated by the mobile working equipment. Examples of such mobile working equipment include demolition and construction equipment, particularly excavators and remote controlled machinery. Booms of such mobile working equipment have, in a well-known manner, a tool end to which attachments may be releasably fixed. Particularly, such tool ends have a defined mechanical coupling interface for this purpose. Correspondingly, the mechanical attachments means 3 are arranged to functionally co-operate with the mechanical coupling interface of the boom's tool end.

The gripping tool 1 further comprises a gripping assembly carriage 8 equipped with at least a fork 4 extending, when in use, substantially horizontally from the base.

For the purpose of clarity, the term ‘when in use’ has been used in the context of this disclosure to describe a situation in which the gripping tool 1 has been attached to tool end of a mobile working equipment located on substantially horizontal level surface while the gripping tool 1 is positioned such that the at least one fork 4 extends substantially horizontally. It should be understood, however, that during actual operating conditions, the positions and orientations of the gripping tool varies.

The gripping assembly carriage 8 further comprises a clamp assembly having a clamp arm 6 equipped with at least a clamp pad 7.

The clamp arm 6 extends substantially in the direction of the at least one fork 4, i.e. the clamp arm 6 extends substantially in the same direction as the at least one fork 4 so as to be positioned, when in use, substantially above the at least one fork 4. The clamp arm 6 is further movable towards and away from the at least one fork 4 for clamping a heat exchanger plate 11 between the at least one fork 4 and the at least one clamp pad 7. It should be noted, that the clamp arm 6 does not need to be parallel with the at least one fork 4, but may extend in an inclined manner.

Preferably, but not necessarily, a mast 5 extending, when in use, substantially vertically is attached to the gripping assembly carriage 8. Accordingly, the clamp arm 6 may then extend from the mast 5 substantially in the direction of the at least one fork 4 and be movable along the mast 5 towards and away from the at least one fork 4 for clamping a heat exchanger plate 11 between the at least one fork 4 and the at least one clamp pad 7

It should be noted, that the clamp arm 6 does not need to be perpendicular to the mast 5, but may extend in an inclined manner.

Furthermore, the movement of the at least one clamp pad 7 towards and away from the at least one fork 4 may alternatively be implemented using any other suitably construction. For example, a lever system construction may be used for realizing the movement of the at least one clamp pad 7 towards and away from the at least one fork 4.

Preferably, but not necessarily, the gripping assembly carriage 8 comprises a pair of forks 4, each fork 4 being spaced apart from each other, side by side. Moreover, the lateral position of the at least one fork 4 is adjustable by attaching the at least one fork 4 to the gripping assembly carriage 8 at different positions in a direction transverse to the at least one fork 4. Suitably, the lateral position of both forks 4 is adjustable.

Preferably, but not necessarily, the clamp arm 6 is equipped with a pair of clamp pads 7, each clamp pad 7 being spaced apart from each other side by side, preferably so as to correspond with the pair of forks 4. That is, each or both clamp pads 7 are suitably positioned above each or both forks 4. The position of the at least one clamp pad 7 or both clamp pads 7 may additionally be laterally adjustable. Particularly, if a pair of clamp pads 7 are provided, the distance between said pair of clamps 7 may be adjusted. Moreover, when the lateral position of each or both clamp pads 7 is adjustable, they may be positioned above the corresponding fork 4 even if the position of the each or both forks 4 is adjusted.

Furthermore, the gripping tool 1 is preferably, but not necessarily, equipped with rotation means 9 for rotating the gripping assembly carriage 8 about a common axis with respect to the base 2. Suitably, this common axis is parallel, or close to parallel, with the at least one fork 4. In other words the gripping assembly carriage 8 may be subjected to a roll movement. This enables the gripping assembly carriage 8, particularly each or both forks 4 thereof, to be oriented so as to be parallel with a heat exchanger plate in a furnace wall even if the heat exchanger plate is not horizontal but inclined laterally with respect to the furnace wall.

Preferably, but not necessarily, the rotation means 9 are arranged between the base 2 and the gripping assembly carriage 8

The gripping tool 1 may also be provided with inclination means for inclining the gripping assembly carriage 8 such that the at least one fork 4 is movable, when in use, between a horizontal position and an inclined position in which the at least one fork 4 is at an angle with respect to the horizontal. In other words the gripping assembly carriage 8 may be subjected to a pitch or tilting movement. This enables the gripping assembly carriage 8, particularly each or both forks 4 thereof, to be oriented to be parallel with a heat exchanger plate in a furnace wall even if the heat exchanger plate is not horizontal but inclined inwardly or outwardly with respect to the furnace wall.

The inclination means may be provided, for example, between the base 2 and the rotation means 9, or between the rotation means 9 and the gripping assembly carriage 8.

It should be noted that inclination of the gripping assembly carriage 8 may alternatively be provided by inclining the tool end of the boom in the mobile working equipment, and consequently, inclining the whole gripping tool 1.

Preferably, but not necessarily, the at least one clamp pad 7, preferably each clamp pad 7, is equipped with a resilient clamp member. Suitably the resilient clamp member is a pad made of elastomer, such as rubber, having a size corresponding to that of the clamp pad 7 and attached thereto. The use of a resilient clamp member enhances the frictional grip between the heat exchange plate 11 and the at least one clamp pad 7. This, in turn, ensures, that the heat exchanger plate to be removed is firmly clamped between the at least one clamp pad and the at least one fork when being pulled out of the furnace wall and/or being transported on an uneven surface.

Preferably, but not necessarily, that the at least one clamp pad 7, preferably each clamp pad 7, is equipped with a claw member 10 extending from the distal end of the clamp pad 7 towards the at least one fork 4. This prevents a heat exchanger plate 11 from being drawn from between the at least one fork 4 and clamp pad 7 when the heat exchanger plate 11 is pulled away from the furnace wall and/or when being transported on an uneven surface.

Preferably, but not necessarily, the gripping tool 1 is hydraulically actuated and comprises power coupling means for hydraulically coupling the gripping tool 1 with a hydraulic system of a mobile working equipment. Such an arrangement is particularly advantageous, as hydraulic power is readily available in conventional mobile working equipment. The skilled person will appreciate than any suitable actuation means, such as electric, pneumatic, hydraulic, or a combination thereof may be used for actuating the movement of the gripping tool 1.

According to a second aspect of the disclosure, a method for removing a heat exchanger plate 11 from a furnace wall during demolition of said furnace after its campaign life is provided. In the method, a mobile working equipment having a boom with a tool end is provided. Examples of such mobile working equipment include demolition and construction equipment, particularly excavators and remote controlled demolition machinery.

Further, a gripping tool 1 according to any of the embodiments of the first aspect, as discussed above, is provided.

The gripping tool 1 is mechanically attached with the tool end of the mobile working equipment. Suitably, the gripping tool is coupled with the tool end of the mobile working equipment so that the gripping tool 1 may be operated by the mobile working equipment.

The at least one clamp pad 7 and the at least one fork 4 of the gripping tool assembly are positioned at a distance from each other, said distance corresponding to at least a thickness of a heat exchanger plate 11 to be removed. In other words, the at least one clamp pad 7 is moved away from the at least one fork 4 so that the heat exchanger plate 11 may be nested between the at least one clamp pad 7 and the at least one fork 4.

The gripping tool 1 is then inserted into the furnace wall such that the at least one fork 4 is positioned below a heat exchanger to be removed and the at least one clamp pad 7 is positioned above said heat exchanger plate to be removed. That is, the at least one fork 4 and at least one clamp pad 7 are inserted into the furnace wall so as to surround the heat exchanger plate to be removed.

The clamp pad 7 is then moved towards the fork 4 such that the heat exchanger plate 11 to be removed is clamped between the at least one fork 4 and the at least one clamp pad 7. This result in that the heat exchanger plate to be removed will become firmly gripped between the at least one fork and the at least one clamp pad 7.

Further, the heat exchanger plate 11 is then removed from the furnace wall by withdrawing the gripping tool 1 away from the furnace wall. This can be done, for example, by retracting the boom of the mobile working equipment away from the furnace wall, or by moving the whole mobile working equipment away from the furnace wall.

Preferably, but not necessarily, the gripping tool 1 is aligned with the heat exchanger plate in the furnace wall before inserting the gripping tool 1 into the furnace wall. Most suitably this is done by rotating the gripping assembly carriage 8, inclining the gripping assembly carriage 8, or both, so as position the at least one fork 4 parallel with the heat exchanger plate 11 in the furnace wall. The gripping assembly carriage 8, may be inclined using inclination means provided on the gripping tool 1, or by using boom functions of the mobile working equipment to incline the whole gripping tool 1.

FIG. 1 illustrates a gripping tool 1 attachable to a boom tool end of a mobile working equipment (not illustrated) via mechanical attachment means 3, which in turn are attached to the base 2 of the gripping tool 1. Rotating means 9 are attached to the base and allow the gripping assembly carriage 8 to be rotated with respect to the base 2. The rotating means 9 may comprise a rotatable bearing for rotatably supporting the gripping assembly carriage 8 on the base 2. A rotating motor 9a such as a hydraulic motor, may be attached to the base and coupled to a circumferential toothing on the rotating means 8 via a gear for actuating a rotational motion of the gripping assembly carriage 8.

The gripping assembly carriage 8 comprises a carriage plate 8a, which is attached to the rotating means 9 on one side. On the other side, carriage bars 8b, 8c are attached to the carriage plate 8a. Particularly, the carriage bars 8b, 8c are arranged for supporting a pair of forks 4. Suitably, the upper carriage bar 8b is equipped with a succession of slots for engaging with a corresponding projecting member on each fork 4 for locking the fork in a longitudinal direction of the carriage bar 8b. Naturally, such slots may be alternatively, or additionally, arranged also on the lower carriage bar 8c.

The mast 5 has been attached to the gripping assembly carriage 8, when in use, substantially vertically. In the accompanying figures, the mast has been attached to the carriage plate 8a via the carriage bars 8b, 8c, but it may alternatively, or additionally, also be attached directly to the carriage plate 8a. Other configurations for attaching the mast to the gripping assembly carriage 8 may also be implemented.

FIG. 2 illustrates the back side, i.e. the side of the mechanical attachment means 3, of the gripping tool 1 in more detail. Particularly, the mechanical attachment means 3 may be provided as a pair of plates having cut-out recessed portions arranged to interlock with corresponding attachment members of the boom's tool end. Suitably, the mechanical attachment means 3 are, when in use, vertically aligned and extend perpendicularly from the base 2.

As can most clearly be seen from FIG. 3, the clamp arm 6 has been arranged to extend from the mast 5 substantially in the direction of the forks 4. It should be noted, that the clamp arm 6 does not need to extend directly towards the fork, nor does it need to extend, when in use, horizontally, but may be inclined with respect to the horizontal.

Clamp pads 7 have been provided at the distal ends of a transverse portion of the clamp arm 6 such that the clamp pads 7 are at a distance from each other. Moreover, the clamp pads 7 are suitably situated in a position corresponding to the forks 4, i.e. above the forks when in use. The clamp pads are equipped resilient members 7a, i.e. elastomer pads having a size corresponding to that of the clamp pads 7, on the side of the clamp pads 7 facing the forks 4.

In addition, claw members 10 are provided in connection with each clamp pad 7. The claw members 10 extend towards the forks 4 from the distal ends of the clam pads 7. Preferably, but not necessarily, the claw members 10 extend just past the tips of the forks 4, such that if the clamp pads 7 are moved to press against the forks 4, the claw members 10 do not contact the forks 4. Suitably, claw members 10 are adjustable, such that their position with respect to their respective clamp pad 7 can be adjusted. Alternatively the claw members 10 may be provided in a fixed manner

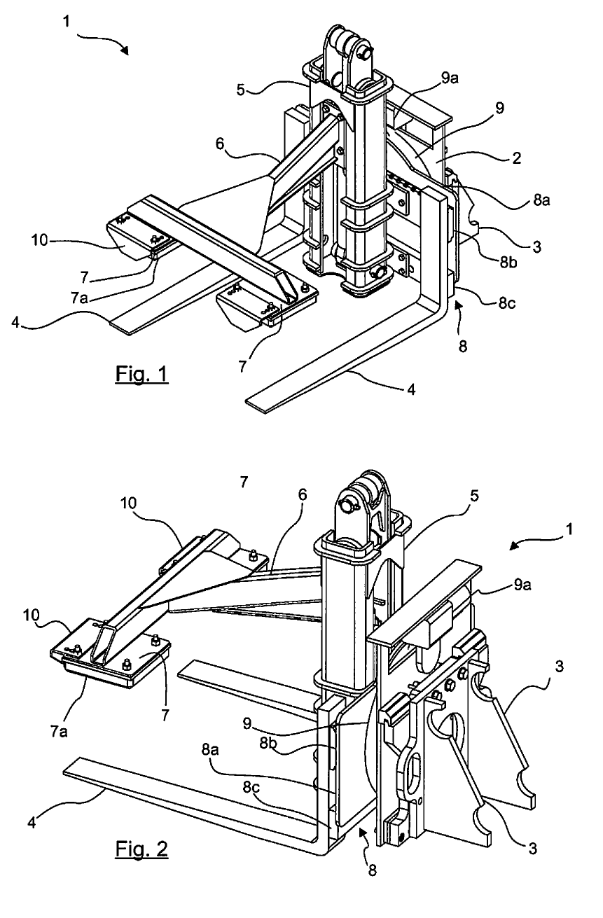

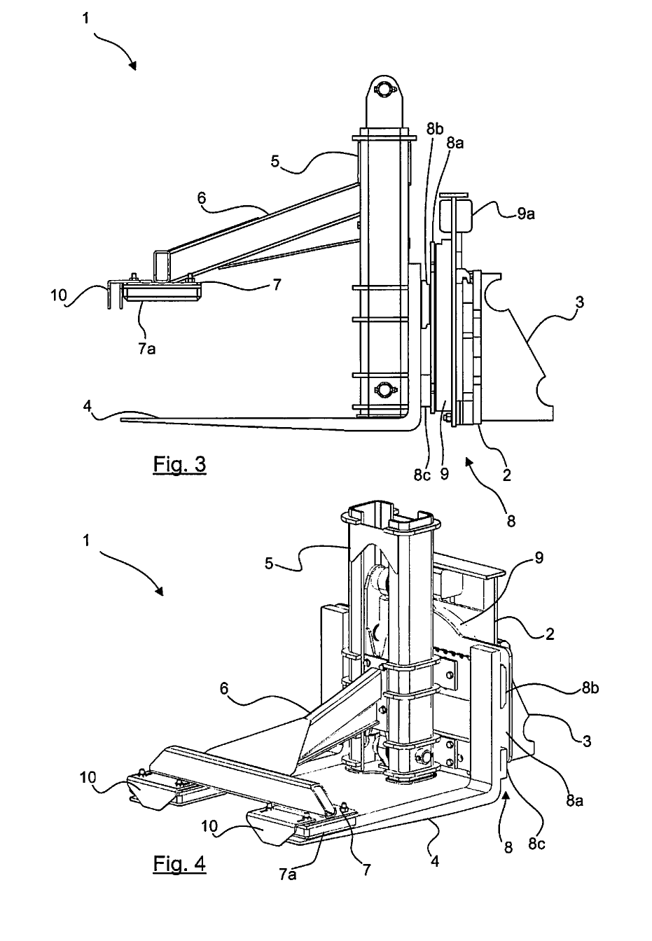

Moreover, the clamp arm 6 has been movably attached to the mast 5, such that the clamp arm 6 may move along the mast 5 in a linear fashion. As can be seen from FIG. 4, for example, the movement of the clamp arm 6 has been provided by a linear actuator, in this case a hydraulic cylinder, within the mast 5, and arranged for moving the clamp arm 6 along the mast 5. It should be noted, that other linear actuators may naturally be used. Examples of such other types of linear actuators are, e.g. electrical and pneumatic linear actuators. Particularly, in FIG. 4 the clamp arm 6 has been moved into its lowermost position, in which the clamp pads 7 are pressed against the forks 4.

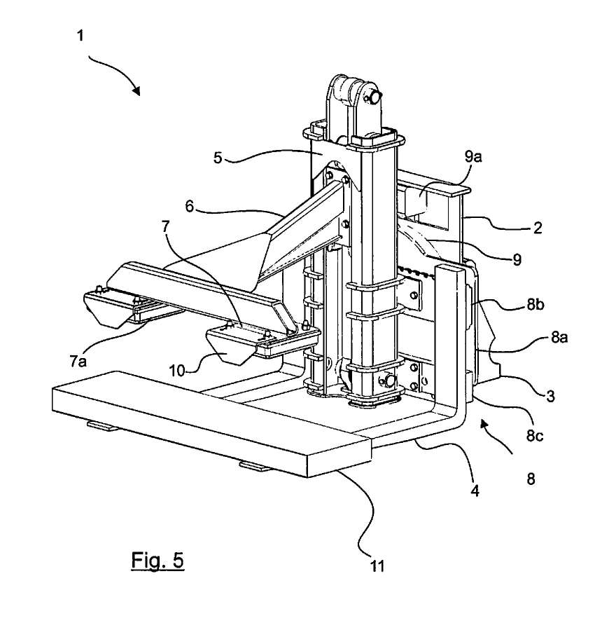

FIG. 5 illustrates a situation in which a typical heat exchanger plate 11 is carried by the forks 4 of the gripping tool 1. It should be noted, however, that the clamp arm 6 has not yet been driven downwards into a clamping position. Consequently, in the situation of FIG. 5 the heat exchanger plate 11 would easily slip of the forks 4 when being pulled out of the furnace wall, or when the mobile working equipment is being operated on an uneven surface. To prevent the heat exchanger plate 11 from slipping off the forks 4, the gripping arm 6 is driven downwardly so that the clamp pads 7, particularly the resilient members 7a thereof, clamp the heat exchanger plate 11 against the forks.

The clamp arm 6 pressing the heat exchanger plate 11 against the forks prevents the heat exchanger plate 11 from moving on the forks 4 in three different ways. Firstly, as the clamp arm 6 is pressed against the heat exchanger plate 11, the movement thereof is restricted, when in use, in the vertical direction. Secondly, the clamp pads 7, particularly the resilient members 7a thereof and the forks 4, engage frictionally with the heat exchanger plate thus preventing the movement of the heat exchanger plate, when in use, in the horizontal directions. Moreover, the claw members 10 restrict the movement of the heat exchanger in the longitudinal direction of the forks 4, so as to prevent the heat exchanger plate 11 falling from the tips of the forks 4. As a significant force is required to pull the heat exchanger plate 11 form the furnace wall, the heat exchanger plate 11 might slip of the forks 4 without the claw members 10, particularly if the heat exchanger plate becomes stuck in the furnace wall.

In the above, the disclosure has been discussed with reference to FIGS. 1-5. However, it is obvious to the skilled person that the scope of the disclosure is not restricted to the embodiments illustrated in the drawings, but the disclosure may be implemented in accordance with the accompanied Claims.

1.-14. (canceled)

15. A gripping tool for removing a heat exchanger plate from a furnace wall, said gripping tool comprising:
a base having mechanical attachment means for releasably fixing said gripping tool to a tool end of a boom of a mobile working equipment so as to be operated by the mobile working equipment, and
a gripping assembly carriage equipped with at least a fork extending, when in use, substantially horizontally from the gripping assembly carriage,
wherein the gripping assembly carriage further comprises a clamp assembly having a clamp arm equipped with at least a clamp pad, wherein
said clamp arm extends substantially in the direction of the at least one fork and is movable towards and away from the at least one fork for clamping a heat exchanger plate between the fork and the clamp pad,
wherein a mast is attached to the gripping assembly carriage, said mast extending, when in use, substantially vertically, wherein the clamp arm extends from the mast substantially in the direction of the at least one fork and is movable along the mast towards and away from the at least one fork for clamping a heat exchanger plate between the at least one fork and the at least one clamp pad, and
wherein the gripping tool further comprises rotation means for rotating, when in use, the gripping assembly carriage about a common axis with respect to the base, said common axis being parallel with the at least one fork.

16. The gripping tool according to claim 15, wherein the gripping assembly carriage further comprises a pair of forks, each fork being spaced apart from each other side by side.

17. The gripping tool according to claim 15, wherein the lateral position of the at least one fork is adjustable by attaching the at least one fork to the gripping assembly carriage at different positions in a direction transverse to the at least one fork.

18. The gripping tool according to claim 15, wherein the clamp arm is equipped with a pair of clamp pads, each clamp pad being spaced apart from each other side by side, preferably so as to correspond with the pair of forks.

19. The gripping tool according to claim 18, wherein the distance between said pair of clamp pads is adjustable.

20. The gripping tool according to claim 15, wherein the rotation means are arranged between the base and the gripping assembly carriage.

21. The gripping tool according to claim 15, wherein the gripping tool further comprises inclination means for inclining the gripping assembly carriage such that the at least one fork is movable, when in use, between a horizontal position and an inclined position in which the at least one fork is at an angle with respect to the horizontal.

22. The gripping tool according to claim 15, wherein the at least one clamp pad, is equipped with a resilient clamp member.

23. The gripping tool according to claim 15, wherein the at least one clamp pad, is equipped with a claw member extending from the distal end of the clamp pad towards the at least one fork for preventing a heat exchanger plate from being drawn from between the at least one fork and clamp pad when the heat exchanger plate is pulled away from the furnace wall.

24. The gripping tool according to claim 15, wherein the gripping tool is hydraulically actuated and comprises power coupling means for hydraulically coupling the gripping tool with a hydraulic system of a mobile working equipment.

25. A method for removing a heat exchanger plate from a furnace wall during demolition of said furnace after its campaign life, said method comprising the steps of:
providing a mobile working equipment having a boom with a tool end;
providing a griping tool according to claim 15;
attaching said gripping tool mechanically with the tool end of the mobile working equipment, so as to be operated by the mobile working equipment;
positioning the at least one clamp pad and the at least one fork of the gripping tool at a distance from each other, said distance corresponding to at least a thickness of a heat exchanger plate to be removed;
inserting the gripping tool into the furnace wall such that the at least one fork is positioned below a heat exchanger plate to be removed and the at least one clamp pad is positioned above said heat exchanger plate to be removed;
moving the clamp pad towards the fork such that the heat exchanger plate to be removed is clamped between the at least one fork and the at least one clamp pad, and
removing the heat exchanger plate from the furnace wall by withdrawing the gripping tool away from the furnace wall.

26. The method according to claim 25, further comprising the step of:
prior to inserting the gripping tool into the furnace wall, aligning the gripping tool with the heat exchanger plate to be removed from the furnace wall by rotating the gripping assembly carriage, inclining the gripping assembly carriage, or both, so as position the at least one fork parallel with the heat exchanger plate in the furnace wall.
